(19) United States
(12) Patent Application Publication
(10) Pub. No.: US 2008/0184176 A1
(43) Pub. Date: Jul. 31, 2008

(54) Systems and Methods for Determining Electrical Characteristics of a Power Distribution Network Using a One-Dimensional Model

(76) Inventor: Satoru Takase, Kanagawa (JP)

Correspondence Address: LAW OFFICES OF MARK L. BERRIER, 3811 BEE CAVES ROAD, SUITE 204, AUSTIN, TX, 78746, US

(21) Appl. No.: 11/627,411

(22) Filed: Jan. 26, 2007

(51) Int. Cl. G06F 17/50

(52) U.S. Cl. 716/2

(57) ABSTRACT

Systems and methods for determining electrical characteristics of systems such as power distribution networks using one-dimensional stimulation of the systems in place of conventional three-dimensional simulation. One embodiment comprises a method for determining the resistance of a power distribution network for an integrated circuit, and includes defining a one-dimensional model of the power distribution network, performing multiple simulations of the one-dimensional model, including each simulation generating a result for the desired network characteristic, and aggregating the results of the simulations. The one-dimensional model comprises an equation in which the overall resistance of the power distribution network is equal to the sum of a coefficient and a representative component resistance value for each layer of the network. The equation is solved for multiple sets of component resistance values to generate a set of network resistance values that are aggregated into a probability distribution.

### BACKGROUND

1. Field of the Invention

The invention relates generally to the design of integrated circuits, and more particularly to systems and methods for determining electrical characteristics of systems such as power distribution networks using one-dimensional stimulation of the systems in place of conventional three-dimensional simulation.

2. Related Art

Integrated circuits contain many individual electronic components, such as transistors, resistors, capacitors, diodes, and the like, which are arranged and interconnected to form larger components, such as logic gates, memory cells, sense amplifiers, etc. These components form even larger components, such as processor cores, bus controllers, and so on, which are used to build devices such as computers, cell phones, PDAs, etc. These electrical components and devices, however, cannot operate without power. It is therefore necessary, when constructing these components and devices, to provide a power distribution network that can supply power from a source which is an external to the integrated circuit to each of the on-chip components of the integrated circuit.

Typically, a power distribution network in an integrated circuit includes multiple metal layers and multiple layers of vias that interconnect the metal layers. The power distribution network also includes contacts for connection to the external power source, as well as contacts to the components of the integrated circuit. Conventionally, each metal layer includes traces that are oriented in a single direction, and the traces of successive metal layers are oriented in different (perpendicular) directions. Power supplied to the power distribution network at a given contact can therefore be transmitted in essentially any direction by connecting the contact to a first trace which extends in one direction, and then connecting the first trace to a second trace which extends in the other direction.

Since the power distribution network of the integrated circuit has its own inherent electrical characteristics, it will affect the power provided to the components of the integrated circuit. For example, because the power distribution network has resistance, it will dissipate some amount of power, and the voltage provided to the integrated circuit components will be somewhat less than the voltage at the contacts to the external power source. Because the power distribution network affects the power supplied to the on-chip integrated circuit components, it is important to know how the on-chip power is affected in order to ensure that the on-chip components operate properly.

This is typically accomplished by modeling the components of the power distribution network and simulating the transfer of power through the network. As noted above, the power distribution network consists of multiple layers of metal and vias. These layers form a three-dimensional structure, so the power distribution network is conventionally modeled as a three-dimensional structure of electrical components (e.g., resistors.) After the three-dimensional model is constructed, expected values for each of the components in the structure can be plugged into the model, and the behavior of the network is stimulated by computing the overall electrical characteristics of the power distribution network (e.g. the resistance of the network between the power source and various locations on the integrated circuit.)

Because each of the components of the power distribution network can have a range of possible values, it is desirable to simulate the behavior of the network using many different sets of possible component values. Typically, a value for each component is selected using a Monte Carlo methodology, in which the probability that a particular value is weighted according to an expected distribution values. In other words, the values selected for a particular component will more likely be close to a median value than very different from this value. The results of the many different simulations of the three-dimensional power distribution network model are then aggregated (e.g., averaged) to determine the overall electrical characteristics of the network.

While this conventional methodology for determining the electrical characteristics of a power distribution network is very useful in designing integrated circuits, it has a number of drawbacks. For example, because three-dimensional modeling of the power distribution network is typically very complicated, simulating the behavior of the network using a three-dimensional model requires a great deal of computing power. Because this method is computationally intensive, it also requires a great deal of time. For instance, a single simulation of the power distribution network (using a single corresponding set of component values) for a multi-core processor may take 10 minutes. If only a single simulation were required, this would not be burdensome, but because of the range of values for each component, many (e.g., 1000, or even 10,000) simulations must be performed and the corresponding results aggregated in order to arrive at a reasonably accurate estimation of the behavior of the power distribution network. The time required for completion of this many simulations is obviously quite large.

It would therefore be desirable to provide systems and methods for determining the behavior of power distribution networks with accuracy comparable to conventional methods, but with much greater computational efficiency, and in much less time.

### SUMMARY OF THE INVENTION

One or more of the problems outlined above may be solved by the various embodiments of the invention. Broadly speaking, the invention includes systems and methods for determining electrical characteristics of systems such as power distribution networks using one-dimensional stimulation of the systems in place of conventional three-dimensional simulation.

One embodiment comprises a method for determining a desired characteristic of a power distribution network for an integrated circuit, such as the overall resistance of the network. This method includes defining a one-dimensional model of the power distribution network, performing multiple simulations of the one-dimensional model, including each simulation generating a result for the desired network characteristic, and aggregating the results of the simulations.

In one embodiment, defining the one-dimensional model comprises defining an equation in which the desired characteristic of the power distribution network is a linear function of the characteristic for each of a plurality of layers in the power distribution network. For example, the overall resistance of the power distribution network may be set equal to the sum of a coefficient and a representative component resistance value for each layer of the network. The coefficients may initially be determined by selecting component values and simulating the power distribution network using a conventional three-dimensional model to generate instances of the equation in which the coefficients are the unknowns, and then solving for these coefficients, either exactly or using regression techniques. In each simulation of the one-dimensional model, the values for each layer of the power distribution network may be selected in a pseudorandom fashion according to probability distributions for the respective layer components. These distributions may be narrowed by determining an area affected by each component and averaging the components in the affected area. The results of the simulations may be aggregated to generate a probability distribution for the desired characteristic of the power distribution network.

Another embodiment of the invention may comprise a computer system that is configured to execute a method such as is described above. The computer system may include any suitable type of data processor and a storage medium which contains instructions executable by the data processor to perform the method. Another embodiment may comprise the storage medium which contains the instructions.

Numerous additional embodiments are also possible.

The various embodiments of the present invention may provide a number of advantages over the prior art. For example, the use of a one-dimensional model to simulate the behavior of a power distribution network may require substantially less computing resources and time to generate a probability distribution of the overall network resistance than is necessary when using conventional three-dimensional modeling.

### BRIEF DESCRIPTION OF THE DRAWINGS

Other objects and advantages of the invention may become apparent upon reading the following detailed description and upon reference to the accompanying drawings.

FIG. 1 is a diagram illustrating a perspective view of several of the metal layers of a typical power distribution network.

FIG. 2 is a diagram illustrating a cross-sectional view of the structure of a typical power distribution network.

FIGS. 3A and 3B are diagrams illustrating typical probability distributions for the values of electrical characteristics of components within the layers of a power distribution network.

FIG. 4 is a flow diagram illustrating a method for determining the overall characteristics (e.g., resistance) of a power distribution network in accordance with the prior art.

FIG. 5 is a diagram illustrating the modeling of a power distribution network as a stack of thin films, each having a corresponding resistance in accordance with one embodiment.

FIG. 6 is a flow diagram illustrating a method for determining the overall characteristics (e.g., resistance) of a power distribution network in accordance with one embodiment.

FIG. 7 is a diagram illustrating a probability distribution for the results generated by the one-dimensional simulations in accordance with one embodiment.

FIGS. 8A and 8B are diagrams illustrating probability distributions for the values of electrical characteristics of individual components and multiple, averaged components within the layers of a power distribution network.

FIG. 9 is a diagram illustrating the configuration of C4 contacts in the uppermost layer of a power distribution network in one embodiment.

FIG. 10 is a diagram illustrating the change in the resistance of the power distribution network as a function of distance from a C4 contact that has a value of 3σ over the mean in accordance with one embodiment.

FIG. 11 is a flow diagram illustrating a method for determining narrowed probability distributions for components in the layers of a power distribution network in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention includes systems and methods for efficiently and accurately determining electrical characteristics such as resistance of systems such as power distribution networks by simulating the system using one-dimensional models in place of computationally intensive conventional three-dimensional models.

In one embodiment, a method for determining the resistance of a power distribution network makes use of a simple equation that varies linearly with the resistance of each layer in the network. Three-dimensional modeling is used to generate values for the resistance of the entire power distribution network, which are then used to determine coefficients by which the layer resistances are multiplied in the equation. After these coefficients are determined, the equation serves as a one-dimensional model for simulations of the power distribution network resistance using different potential values for the layer resistances.

In this embodiment, the power distribution network is viewed as a set of serially connected resistors, with each resistor representing one of the layers (contacts, metal, vias) of the network. The total resistance of the power distribution network is then the sum of the resistances of each of the layers. This is represented by the equation:

R_{network}=Σ(Aᵢ*Rᵢ)

where R_{network} is the resistance of the network, Rᵢ is the resistance of a particular layer in the network such as sheet resistance for wire or via resistance for vias, and Aᵢ is a coefficient by which the resistance Rᵢ is multiplied. R_{network} is therefore a function of the resistance of each layer. The coefficients Aᵢ scale the resistance of each layer as represented by Rᵢ.

Initially, the coefficients Aᵢ are unknown. In order to determine the values of these coefficients, various potential values of each layer's resistance are plugged into a conventional three-dimensional model, which is then stimulated to determine the total resistance of the power distribution network. This produces an equation in which the resistance values are known, but the coefficient values are unknown. The process of simulating the three-dimensional model is repeated with different resistance values for the layers in order to generate additional equations, each with known resistance values and unknown coefficient values. When enough of these equations have been generated (i.e., as many equations as there are unknown coefficients,) the equations can be used to solve for the coefficients. The values of the coefficients can then be inserted into the original equation, so that the total resistance of the power distribution network is a function only of the layer resistance values.

The equation is then used as a one-dimensional model of the power distribution network. This one-dimensional model is used to perform repeated simulations using the potential resistance values for each of the layers. The one-dimensional model (the equation) is used in the same manner in which the three-dimensional model is conventional used, but each simulation using the one-dimensional model requires far less computational power and far less time than a corresponding simulation using the three-dimensional model. In fact, the use of the one-dimensional model may reduce the computational and time requirements by a factor of between 100 and 1000. Despite the greater efficiency of the one-dimensional model, the results generated using this model are comparable in accuracy to results generated using conventional three-dimensional models.

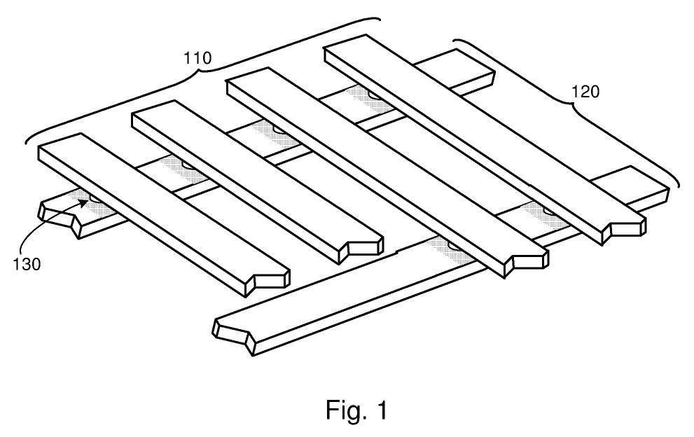

Before describing the exemplary embodiments of the invention in detail, it will be helpful to examine the structure of the power distribution network which is to be modeled. As noted above, the power distribution network consists of various layers that form and interconnecting network extending from an external power source to the various on-chip components of the integrated circuit. Referring to FIG. 1, a diagram providing a perspective view of several of these layers is shown. More specifically, FIG. 1 shows two of the metal layers in the network. It can be seen that the upper metal layer 110 consists of a series of traces that are oriented in a first direction. A lower metal layer 120 has a similar series of traces, but the traces are oriented in a second direction which is perpendicular to the first direction. Between layers 110 and 120 is a layer of vias 130 that connect traces in layer 110 to traces in layer 120. By in the traces of the different metal layers, power can be distributed to many different points across the area of the integrated circuit.

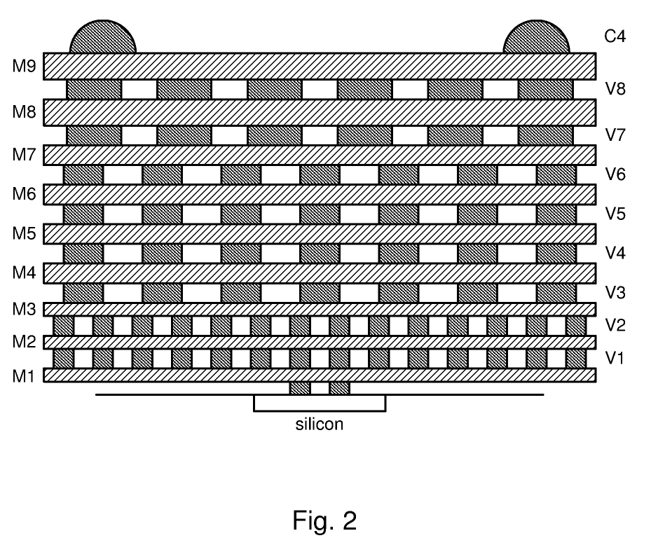

Referring to FIG. 2, a diagram illustrating a cross-sectional view of the structure of the power distribution network is shown. The power distribution network depicted in this figure includes nine different metal layers, indicated as M1-M9. (While the traces of successive metal layers are oriented in different directions, these layers are depicted as solid, unbroken layers for purposes of clarity.) Between the metal layers are eight layers of vias, indicated as V1-V8. The traces of layer M1 are connected to the traces of layer M2 by vias in layer V1, traces of layer M2 are connected to traces of layer M3 by vias in layer V2, and so on. There are also two layers (CA and C4) which consist of contacts. Contact layer CA connects traces of metal layer M1 to components on the surface of the integrated circuit chip, while contact layer C4 connects traces of metal layer M9 to the external power source.

It can be seen that there are some differences between the various layers shown in FIG. 2. For example, the metal layers have several different thicknesses. Likewise, the vias in the different layers have varying sizes and spacings. The contacts in layer CA also have different sizes and spacings than the contacts in layer C4. These differences may result from a variety of design considerations. For example, the traces in metal layer M9 may have to carry larger currents than the traces of lower metal layers, so it may be necessary to make these traces wider and more thick than the traces in the lower layers. The same may be true of the contacts and vias in the other layers. As a result of these differences, each layer may have different electrical characteristics. For instance, because the contacts in layer C4 may be fewer in number and larger than the contacts in layer CA, the contacts in layer C4 may have a greater resistance per unit area than the contacts in layer CA.

As pointed out above, the characteristics of the power actually provided to components of the integrated circuit are not identical to the characteristics of the power applied by the power source at the external (C4) contacts of the power distribution network because of the electrical characteristics of the power distribution network itself. It is therefore necessary to determine the characteristics of the power distribution network that will affect the power applied to the integrated circuit components. Conventionally, this is accomplished through the use of simulations employing a three-dimensional model of the power distribution network.

Using conventional methods, the power distribution network was modeled very precisely using design tools such as SPICE. These tools allow a user to define the three-dimensional structure of the power distribution network. The user can then input data associated with the individual components of the network (e.g., the resistance of each contact or trace) to define the electrical characteristics of the network at a component level. Then, to determine overall characteristics such as the total resistance of the power distribution network, the user can simulate the behavior of the network (i.e., compute the overall electrical characteristics based upon the component characteristics.) Because of the complexity of the three-dimensional model, the simulation of the power distribution network's behavior, assuming one particular set of values for component characteristics, requires a great deal of computing resources and time. A single simulation can, for instance, take 10 minutes.

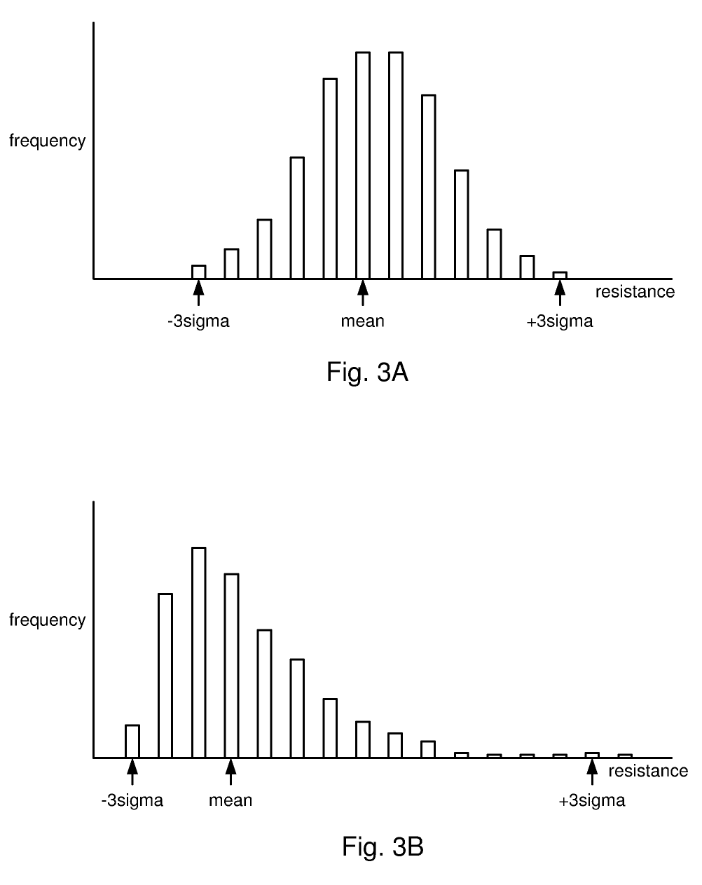

A single simulation, however, is not normally sufficient to determine the overall behavior of the power distribution network. As noted above, a particular simulation is based upon a corresponding set of values that are assumed for each component within the network. Because of manufacturing tolerances and various other factors, the actual value of a particular component characteristic may vary among “identical” components. More specifically, the values of these characteristics normally vary according to a particular probability distribution associated with the component. These probability distributions may vary, but an exemplary distribution is depicted in FIG. 3A.

Referring to FIG. 3A, it can be seen that the possible values for a particular characteristic of a particular component may fall anywhere within the depicted probability distribution. In this example, the values will tend to be clustered around the mean value x. The likelihood that a component will have a particular value decreases in this example as the distance from x increases, but the values will be scattered throughout the values included in the distribution. It should be noted that other probability distributions are possible, and these distributions may be non-symmetric or may otherwise differ from the one shown in FIG. 3A (see FIG. 3B.) Because, in reality, the value of a particular characteristic for a particular component may vary within a corresponding probability distribution, it is necessary to account for the variations in the simulation of the power distribution network.

This is accomplished by performing multiple simulations using a Monte Carlo methodology. In other words, the particular component characteristic values for each simulation are selected in a random (or pseudorandom) fashion according to corresponding probability distributions. Thus, a component having a probability distribution similar to that shown in FIG. 3A will select values that are more likely to be clustered around x, and it less likely to be widely scattered from x. Because each of the components of the power distribution network has similar variations in the characteristics of interest, it is necessary to perform a large number of simulations in order to try to account for the many different combinations of values for the different components. As mentioned above, it is typically necessary to perform thousands of simulations.

The results of the simulations are typically aggregated to generate a distribution for the power distribution network which is similar to that of the individual components of the network. In other words, the results of the simulations will vary according to a probability distribution that is characteristic of the power distribution network. This probability distribution may, for example, be similar to the one shown in FIG. 3A, such that most of the results are grouped near a particular value, and the likelihood that a simulation result differs from this value decreases with the distance from this value.

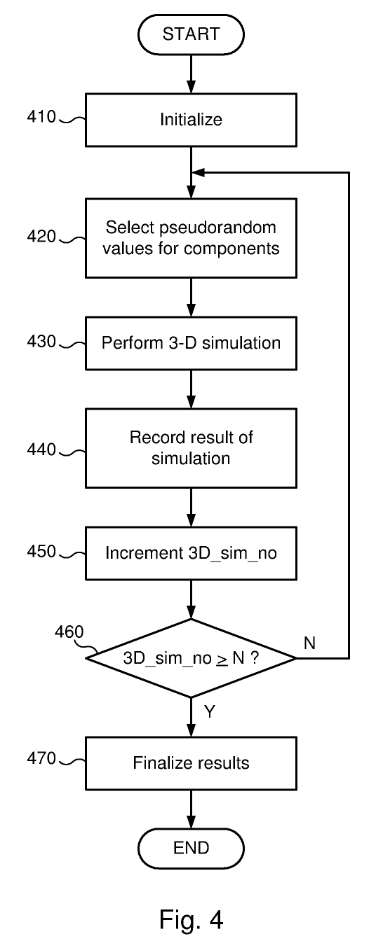

The conventional methodology for determining the overall characteristics of the power distribution network (e.g., determining a probability distribution for the overall resistance of the network) can therefore be summarized as shown in FIG. 4. The conventional method begins with initialization of the model (410,) including setting a simulation counter to 0. Pseudorandom values are then selected for each of the power distribution network components according to the corresponding probability distributions (420.) After the component values are selected, a simulation of the power distribution network is performed using the three-dimensional model of the network (430.) The result of the simulation is then recorded (440,) and the simulation counter is incremented (450.) The simulation counter is then compared to a desired number, N, of simulations (460.) If the simulation counter is less than N, the desired number of simulations has not yet been performed, and the process is repeated, beginning with the selection of a new set of pseudorandom values for the network components (420.) If the simulation counter is greater than or equal to N, the desired number of simulations has been performed, so the results of the simulations are finalized (470,) such as by aggregating the results to form a probability distribution for the results.

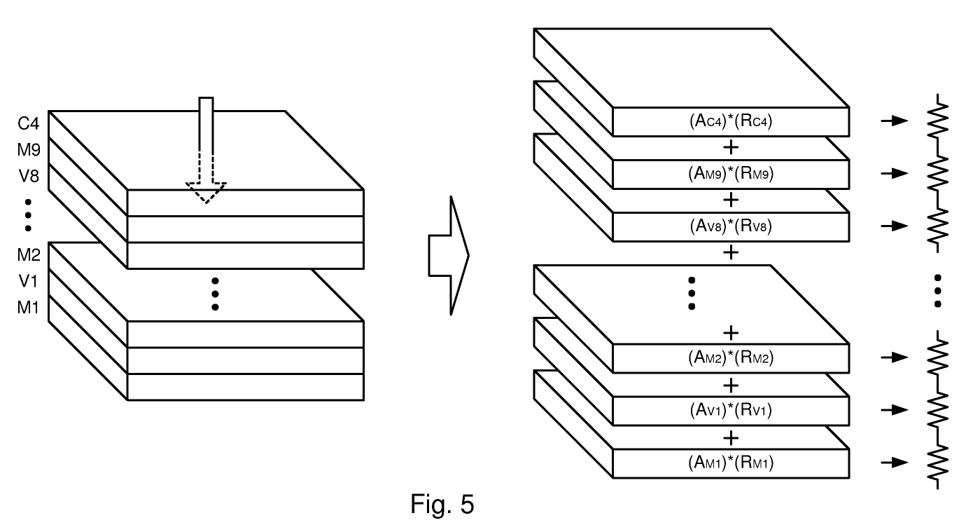

In the embodiments of the present invention, the bulk of the repeated simulations based on the three-dimensional model are replaced by more computationally efficient and less time-consuming simulations of a one-dimensional model. The one-dimensional model for simulating the resistance of the power distribution network is based upon a view of the network as a stack of resistive thin films, as shown in FIG. 5. (The one-dimensional model of the network may be different when computing other electrical characteristics.) As described above, the power distribution network includes multiple layers of metal traces, vias and contacts. Each of these layers is viewed as one of the resistive thin films in the stack. The resistance of the power distribution network from the top of the stack (where the network is connected to the external power source) to the bottom of the stack (where the network is connected to the on-chip components of the integrated circuit) is therefore the sum of the resistances of the thin films.

The resistance of each layer is represented by of the product of a representative resistance and a corresponding coefficient. The representative resistance may, for example, be the resistance of one of the vias when considering a via layer, or the sheet resistance of one of the traces when considering a metal layer. The coefficient corresponding to the representative resistance effectively scales this resistance to correspond to a unit area (e.g., 1 mm2) of the layer. The resistance of the power distribution network can therefore be represented by the equation:

R_{network}=A_{C4}*R_{C4}+A_{M9}*R_{M9}+A_{V8}*R_{V8}+ . . . +A_{CA}+*R_{CA}

where R_{network} is the resistance of the network, R_{[layer]} is the resistance of the corresponding layer, and A_{[layer]} is the coefficient corresponding to the layer resistance R_{[layer]} (the layer identifier, e.g., C4, M9, etc. is substituted here for “[layer]”.) The resistance can alternatively be represented by the equation:

R_{network}=Σ(Aᵢ*Rᵢ)

where Aᵢ and Rᵢ correspond to layer i, and the summation is over all the layers. The equivalent serially connected resistors are depicted at the right side of FIG. 5.

Initially, coefficients Aᵢ are unknown, so this equation (in either of the forms above) cannot be used to determine the resistance of the power distribution network. It is therefore necessary to determine these coefficients so that the equation can be used to simulate the resistance of the power distribution network in place of the conventional simulation based on the three-dimensional model. This is accomplished by identifying resistance values that can be plugged into multiple instances of the equation, and then using these instances of the equation to solve for the coefficients. This will be explained in more detail below.

The first step in this process is to select resistance values to plug into the equation. The resistance value for each layer can be determined from manufacturing data for the components (traces, vias, contacts) that make up the layer. For instance, with respect to a via layer, the nominal resistance of a single via and the number of a vias per-unit area are known. A resistance per-unit area can be determined from this information. The resistance per-unit area can then be plugged into the equation as Rᵢ, where i is the identifier for the corresponding layer. This can be repeated for each layer to determine the corresponding resistance values that will be plugged into the right side of the equation.

It is still necessary, however, to determine R_{network}, so that this value can be plugged into the left side of the equation, leaving only the coefficients, Aᵢ, as unknowns. In one embodiment, R_{network} is determined conventionally. That is, the values that were used to determine Rᵢ for each layer are plugged into the three-dimensional model, which is then simulated to generate a value for R_{network}. This value is then plugged into the equation to produce one instance of the equation in which all the resistance values are known, and all the coefficient values are unknown.

The process of selecting power distribution network component resistance values, calculating layer resistances Rᵢ and simulating the three-dimensional power distribution network to generate a network resistance R_{network} is then repeated to generate multiple instances of the equation. In each iteration of this process, a different set of resistance values is selected for the network components, so that each instance of the equation will have different resistance values. The set of resistance values for each iteration can be selected in the same manner as is used in the conventional simulation process (i.e., “randomly” selecting values according to the probability distribution of each network component,) although this is not necessary.

The process is repeated a sufficient number of times to generate as many different instances of the equation as there are unknown coefficients in the equation. The equations can then be used to solve for the coefficients Aᵢ exactly using well-known methods. If desired, the number of different instances of the equation can be greater than the number of unknown coefficients, in which case the “best-fit” solution for the coefficients can be determined using linear regression. Tools for this purpose are readily available (e.g., the LINEST function in Microsoft Excel.) After the coefficients have been determined, they can be plugged into the equation, which then defines the power distribution network resistance as a function of each layer's resistance, which can be determined as described above.

The equation thus provides a one-dimensional model for simulation of the resistance of the power distribution network. This one-dimensional model can be used in place of the three-dimensional model which is simulated as described in connection with FIG. 4. The pseudorandom selection of network component resistance values can proceed in the same way, and the same result (a network resistance value) is generated. Because, however, simulation of the network using the one-dimensional model drastically reduces the amount of computational resources and time required for the many simulations in comparison to simulations using the three-dimensional model, use of the one-dimensional model is vastly more efficient.

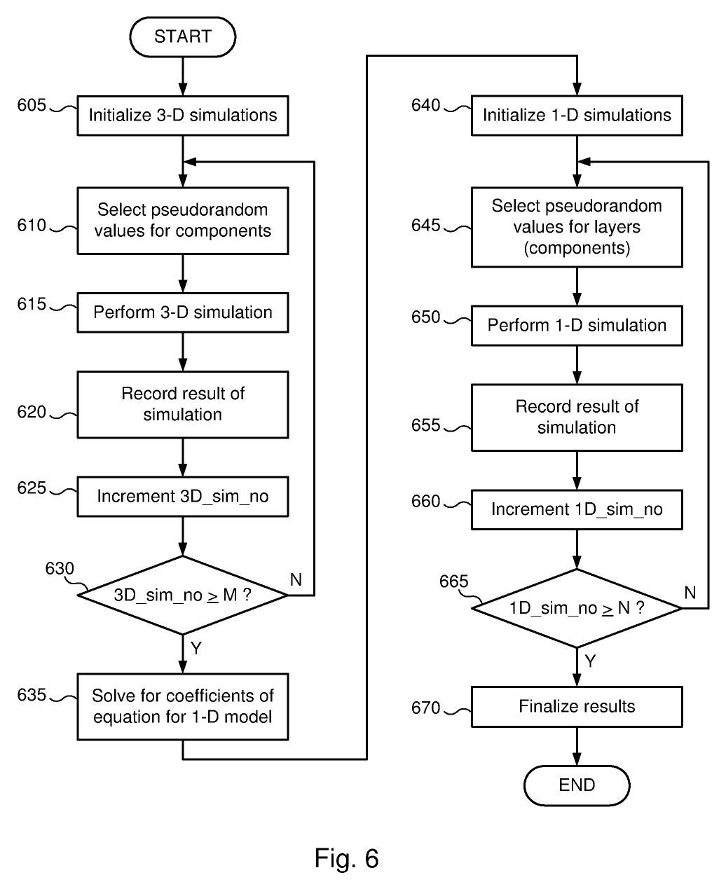

The process of determining the power distribution network resistance using simulations of the one-dimensional model is summarized in the flow diagram of FIG. 6. The method of FIG. 6 begins with initialization of the model (605.) In this embodiment, initialization includes resetting a counter for three-dimensional simulations (3D_sim_ctr.) Pseudorandom values are then selected for each of the components of the power distribution network (610.) These values are selected according to the probability distributions associated with each of the components, as will be discussed in more detail below. Using the selected component values, the behavior of the power distribution network (e.g., the resistance of the network) is simulated using the three-dimensional model (615.) The result of this simulation is recorded (620,) and the simulation counter (3D_sim_ctr) is incremented (625.) If the simulation counter is less than the desired number of three-dimensional simulations (M,) new pseudorandom values are selected for the components, and another three-dimensional simulation is performed (610-615.) This is repeated until a desired number of three-dimensional simulations has been performed,

As noted above, the purpose of performing the three-dimensional simulations is to provide overall results for the power distribution network corresponding to the selected component values, so that the one-dimensional model (the equation that varies linearly with the component value for each layer) can be solved to determine the coefficients in the equation corresponding to each layer (635.) The three-dimensional simulation should therefore be performed at least once for each

coefficient. If additional three-dimensional simulations are performed, the results can be used to solve for the coefficients using common regression techniques. After the coefficients for the one-dimensional model have been determined, the model can be used to determine the desired characteristic (e.g., resistance) of the power distribution network by selecting a component value for each layer and solving for the overall power distribution network value.

After the coefficients have been determined for the one-dimensional model, the one-dimensional simulation is initialized (640.) In particular, a counter for the number of one-dimensional simulations is set to 0. Pseudorandom component values are then selected for each of the layers in the power distribution network (645.) A single representative component value is selected for each layer. The one-dimensional model is then simulated, i.e., the equation is solved to determine the overall power distribution network value (650.) The result of the simulation is recorded in the same manner as for the three-dimensional simulation (655,) and the simulation counter (1D_sim_ctr) is incremented (660.) The simulation counter is then compared to a number, N, of desired simulations (665.) If the counter is less than N, additional simulations are performed, each with a new set of pseudorandomly selected representative component values, and the results are recorded. If the counter is greater than or equal to N, the results are finalized (670,) such as by aggregating the individual results to generate a distribution of the resulting power distribution network values.

As mentioned above, the values selected for the various components of the power distribution network are selected in a pseudorandom fashion in accordance with associated probability distributions. Examples of these probability distributions are shown in FIGS. 3A and 3B. FIG. 3A is a typical probability distribution for the resistance of a metal layer in the power distribution network, while FIG. 3B is a typical distribution for the resistance of a via layer in the network. Each probability distribution is characterized by a mean value, a −3σ (−3sigma) value and a +3σ (+3sigma) value. The value of a particular component represented by one of these distributions may have any of the values within the distributions. The probability that the component will have a particular value corresponds to the height of the probability distribution curve. It can be seen that the distribution of values for components in the metal layer (see FIG. 3A) are roughly symmetric about the mean value, while the distribution of values for components in the via layer (see FIG. 3B) are not.

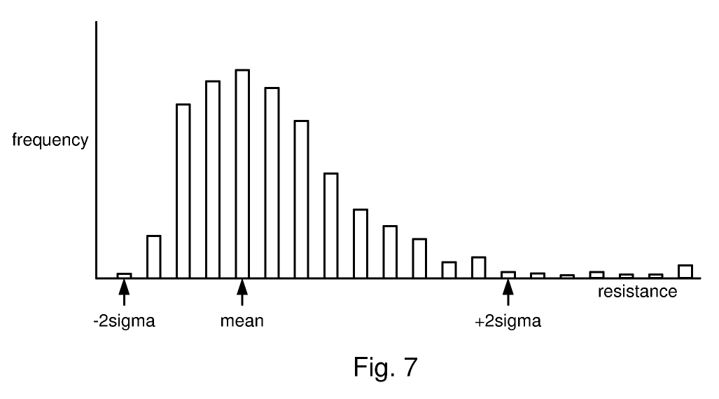

When a Monte Carlo methodology is used in the simulation of the power distribution network, a single value is selected for each component in the network according to the associated probability distributions. Identical components may therefore have different values. Once a value has been selected for each component, the power distribution network is modeled (i.e., the value of the equation representing the one-dimensional model is calculated) using the selected values. This results in a corresponding overall value for the power distribution network. After this value has been determined, the simulation process may be repeated, with new values being selected for each of the components, and a corresponding result being generated for the power distribution network as a whole. Ultimately, the values generated by simulating the power distribution network may be aggregated to form a probability distribution for the network itself. A typical probability distribution for the power distribution network itself is shown in FIG. 7. In this example, the probability distribution for the network is asymmetric and is characterized by a mean value, as well as −2σ (−2sigma) and +2σ (+2sigma) values.

While the one-dimensional simulation of the power distribution network described above produces results with accuracy comparable to conventional three-dimensional methods, additional features can be incorporated to further improve the accuracy of the present one-dimensional methods. One such feature is based upon recognition of the fact that the probability distribution for a group of components in a particular layer, considered together, is more narrow than the probability distribution for a single one of the components.

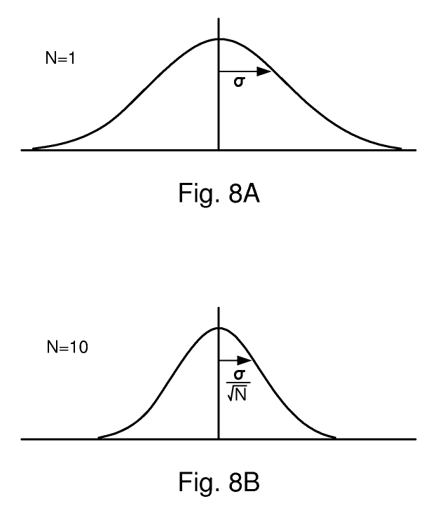

Referring to FIGS. 8A and 8B, a pair of curves showing probability distributions for components in a particular layer of a power distribution network are shown. The probability distribution shown in FIG. 8A corresponds to the distribution of possible values for a single component. The probability distribution shown in FIG. 8B corresponds to the distribution of possible average values for a group of components, where each of the components individually has a probability distribution identical to that shown in FIG. 8A.

The probability distribution of FIG. 8A may be characterized by a nominal value and an indication of the width of the distribution. The distribution may, for example, be a normal distribution characterized by a mean value x and a standard deviation value σ. Mean x is the value that a component would most likely have, although higher or lower values are possible. Standard deviation σ defines the width of the probability distribution and the likelihood that the component will have a value that is some distance from x.

The probability distribution of FIG. 8B can also be characterized by a characteristic mean and standard deviation. In this case, the probability distribution corresponds to the average value of ten components which are identical to the component characterized by the probability distribution of FIG. 8A. Because the components are identical, the mean of the probability distribution shown in FIG. 8B is the same as that of FIG. 8A. The standard deviation, however, is smaller (i.e., the probability distribution is more narrow) because some of the components may have values greater than x, while others have values less than x. While the average value of the ten components may vary around x, the variation will be less than that of an individual component. In fact, the standard deviation of the probability distribution in FIG. 8B is less than the standard deviation of the probability distribution in FIG. 8A by a factor of 1/(N̂(½)), where N is the number of components being averaged (10).

As described above, the purpose of simulating the power distribution network is to determine an electrical characteristic of the power distribution network such as resistance. The resistance of the power distribution network between the external power source and a particular point on the integrated circuit chip is dependent upon multiple components in each layer of the network, so the probability distribution used to simulate the components should take into account the fact that the average of these components will have a more narrow distribution than the individual components.

If the probability distribution for components in a particular layer of the power distribution network is to be narrowed to represent the average of multiple components, the number of components being averaged must be determined. Because a particular component has a greater impact at points closer to the component than at points which are farther away, the number of components to be averaged should be less than all of the components in the layer. In one embodiment, an effective radius is defined, such that components within the effective radius are averaged. The determination of this effective radius in accordance with one embodiment will be described in more detail below, but it should be noted that other methods may be used to determine the number of components to be averaged.

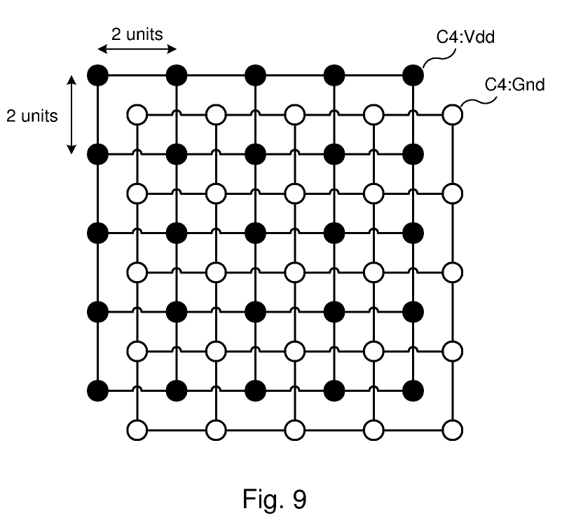

Referring to FIG. 9, a diagram illustrating the configuration of C4 contacts in the uppermost layer of the power distribution network is shown. (These contacts are used in this example because they are the greatest contributor to the resistance of the power distribution network.) If all of the contacts in this layer have identical resistance values, the resistance of the power distribution network will be the same across the integrated circuit (assuming the components of the other layers are also homogeneous.) If, however, one of the C4 contacts has a value which is 3σ above the for these contacts, the resistance of the power distribution network will be higher at points on the integrated circuit nearer this contact, and lower at points on the integrated circuit which are farther away from this contact.

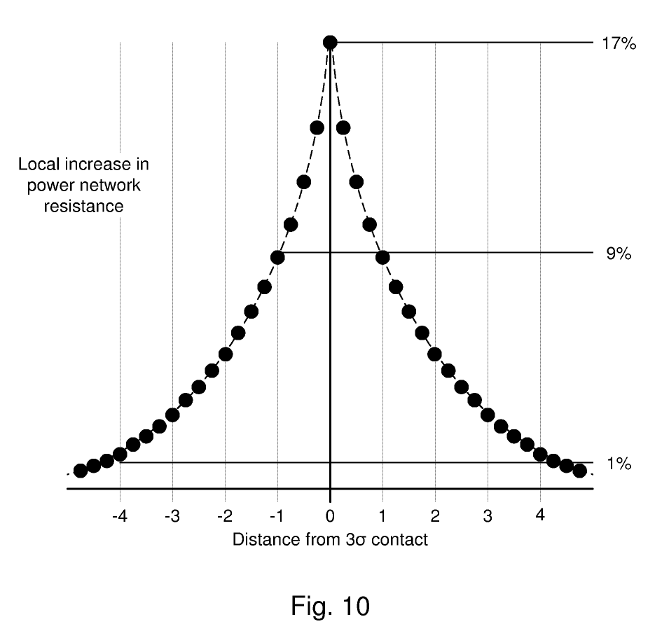

Referring to FIG. 10, a diagram illustrating the change in the resistance of the power distribution network as a function of distance from the 3σ contact in one embodiment is shown. The resistance is shown as a percentage increase above the resistance when all contacts in the C4 layer have identical resistance values. It can be seen that the increase in resistance of the power distribution network is greatest at the point nearest the 3σ contact, and drops off as the distance from this contact increases. At the point nearest the 3σ contact, the power distribution network resistance increases by approximately 17%. At a 1 unit distance from this point, the increase drops to approximately 9%, and at a distance of 4 units, the increase is only about 1%.

In this embodiment, the effective radius for the C4 contact is selected as the radius beyond which the resistance increase due to the 3σ contact is less than about half of the increase nearest this contact, or about 1 unit distance. It should be noted that the particular criteria used to determine the effective radius is somewhat arbitrary, and may be selected based upon various factors, including three-dimensional simulations, empirical data, heuristics, etc. Once the effective radius has been defined, the number of C4 contacts that fall within the effective radius is used to determine the probability distribution of the average resistance value of these contacts (which has a σ value that is reduced by the square root of the number of contacts in the effective radius.) This distribution can then be used in place of the distribution for a single C4 contact in the one-dimensional (and/or three-dimensional) simulations described above.

The determination of the effective radius in the example above was made with respect to the uppermost layer of the power distribution network—the C4 contact layer. The same method can be used to determine effective radii for components in each of the layers of the power distribution network. It should be noted, however, that the impact of determining the effective radius and the resulting narrowed probability distribution for components in a particular layer will vary from one layer to another. The C4 layer was used in the foregoing example because this layer typically provides the greatest contribution to the resistance of the power distribution network. Averaging the components values in this layer will therefore be more significant than averaging the values of components in layers which contribute less resistance and have less impact on the total resistance of the power distribution network. It is therefore contemplated that some embodiments may use the foregoing method to narrow the probability distribution of components in only a few of the layers (e.g., C4, M9, M8,) while other embodiments may do so with respect to all the layers.

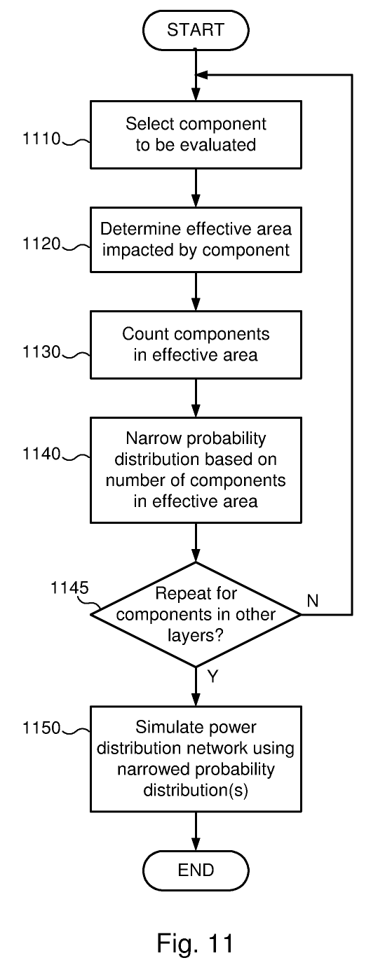

The foregoing method for determining a narrowed probability distribution for the components of a power distribution network can be summarized by the flow diagram of FIG. 11. As shown in this figure, a set of components to be evaluated is selected (1110.) This selection may, for example, be based upon an evaluation of which components have the greatest impact on the cover distribution network as a whole. Then, an area affected by a corresponding one of the components is determined (1120,) such as by defining an effective radius. Once this area has been determined, the number of components that fall within this area is determined (1130.) This number is then used to reduce the standard deviation of the probability distribution, thereby narrowing the distribution (1140.) These steps can be repeated to narrow the probability distributions of components in other layers of the power distribution network, as desired (1145.) The narrowed probability distribution can then be used in the simulation of the power distribution network (1150) as described above

It should be noted that alternative embodiments of the invention may include many variations of the features disclosed above. For example, while the disclosure focuses on an exemplary embodiment in which it is desired to determine the overall resistance of a power distribution network, the same methods can be used to determine other electrical characteristics. Similarly, the disclosed methods can be used to determine the characteristics of systems other than power distribution networks. Many such variations will be apparent to persons of skill in the field of the invention.

It is contemplated that the methods described above will most likely be implemented in a computer system. Embodiments of the invention may therefore include methods as described above, computer systems configured to execute such methods and software programs which contain instructions configured to cause a computer system to execute such methods. The computer systems may include general purpose processors, digital signal processors (DSPs,) controllers, microcontrollers, state machines or other data processors or logic devices configured to execute the described methods. The computer systems may be implemented as a combination of computing devices, e.g., a combination of a DSP and a microprocessor, a plurality of microprocessors, one or more microprocessors in conjunction with a DSP core, or any other such configuration.

The software programs may reside in any computer-readable medium, such as RAM memory, flash memory, ROM memory, EPROM memory, EEPROM memory, registers, hard disk, a removable disk, a CD-ROM, or any other form of storage medium known in the art. A storage medium containing program instructions that embody any of the present methods is itself an alternative embodiment of the invention. The storage medium may be coupled to a processor, such that the processor can read information from, and write information to, the storage medium. The storage medium may alternatively be integral to the processor.

Those of skill in the art will understand that information and signals may be represented using any of a variety of different technologies and techniques. For example, data, instructions, commands, information, signals, bits, symbols, and the like that may be referenced throughout the above description may be represented by voltages, currents, electromagnetic waves, magnetic fields or particles, optical fields or particles, or any combination thereof. The information and signals may be communicated between components of the disclosed systems using any suitable transport media, including wires, metallic traces, vias, optical fibers, and the like.

Those of skill will further appreciate that the various illustrative logical blocks, modules, circuits, and algorithm steps described in connection with the embodiments disclosed herein may be implemented as electronic hardware, computer software (including firmware,) or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A method for determining a desired characteristic of a power distribution network for an integrated circuit, the method comprising:
defining a one-dimensional model of the power distribution network;
performing multiple simulations of the one-dimensional model, further comprising in each simulation, generating a result for the desired characteristic of the power distribution network; and
aggregating the results of the simulations.

2. The method of claim 1, wherein defining the one-dimensional model of the power distribution network comprises defining an equation in which the desired characteristic of the power distribution network is a linear function of the characteristic for each of a plurality of layers in the power distribution network.

3. The method of claim 2, wherein the desired characteristic of the power distribution network comprises a resistance of the power distribution network and wherein the function comprises a sum of layer resistance values, each layer resistance value comprising the product of a coefficient and a representative component resistance.

4. The method of claim 3, wherein defining the equation comprises determining the coefficients by: generating multiple instances of the equation wherein in each instance the resistance of the power distribution network and the layer resistance values are known; and solving the instances of the equation to determine the coefficients.

5. The method of claim 4, wherein for each instance of the equation, the resistance of the power distribution network is determined by performing a simulation of a three-dimensional model of the power distribution network.

6. The method of claim 4, wherein the number of instances of the equation is equal to the number of coefficients, and the instances of the equation are solved to determine an exact value for each of the coefficients.

7. The method of claim 4, wherein the number of instances of the equation is greater than the number of coefficients, and the instances of the equation are solved using regression techniques to determine a best-fit value for each of the coefficients.

8. The method of claim 2, wherein performing each simulation of the one-dimensional model comprises selecting, in a pseudorandom fashion, a value for the characteristic for each of the layers in the power distribution network and solving the equation for the desired characteristic of the power distribution network.

9. The method of claim 8, wherein the values for the characteristic for each of the layers are selected using a Monte Carlo method according to probability distributions associated with the layers.

10. The method of claim 9, further comprising defining the probability distributions associated with at least one of the layers by: defining an effective area impacted by a component in the layer; counting a number N of components in the effective area; and defining the probability distribution associated with the layer as a probability distribution associated with the component, except that the standard deviation of the probability distribution associated with the layer is equal to the standard deviation of the probability distribution associated with the component divided by the square root of N.

11. The method of claim 1, wherein aggregating the results of the simulations comprises generating a probability distribution for the desired characteristic of the power distribution network based on the results of the simulations.

12. A software program product comprising a computer-readable medium containing instructions configured to cause a computer to perform the method comprising:
defining a one-dimensional model of the power distribution network;
performing multiple simulations of the one-dimensional model, further comprising in each simulation, generating a result for the desired characteristic of the power distribution network; and
aggregating the results of the simulations.

13. The software program product of claim 12, wherein defining the one-dimensional model of the power distribution network comprises defining an equation in which the desired characteristic of the power distribution network is a linear function of the characteristic for each of a plurality of layers in the power distribution network.

14. The software program product of claim 13, wherein the desired characteristic of the power distribution network comprises a resistance of the power distribution network and wherein the function comprises a sum of layer resistance values, each layer resistance value comprising the product of a coefficient and a representative component resistance.

15. The software program product of claim 14, wherein defining the equation comprises determining the coefficients by:
generating multiple instances of the equation wherein in each instance the resistance of the power distribution network and the layer resistance values are known; and solving the instances of the equation to determine the coefficients.

16. The software program product of claim 15, wherein for each instance of the equation, the resistance of the power distribution network is determined by performing a simulation of a three-dimensional model of the power distribution network.

17. The software program product of claim 15, wherein the number of instances of the equation is equal to the number of coefficients, and the instances of the equation are solved to determine an exact value for each of the coefficients.

18. The software program product of claim 15, wherein the number of instances of the equation is greater than the number of coefficients, and the instances of the equation are solved using regression techniques to determine a best-fit value for each of the coefficients.

19. The software program product of claim 13, wherein performing each simulation of the one-dimensional model comprises selecting, in a pseudorandom fashion, a value for the characteristic for each of the layers in the power distribution network and solving the equation for the desired characteristic of the power distribution network.

20. The software program product of claim 19, wherein the values for the characteristic for each of the layers are selected using a Monte Carlo method according to probability distributions associated with the layers.

21. The software program product of claim 20, further comprising defining the probability distributions associated with at least one of the layers by: defining an effective area impacted by a component in the layer; counting a number N of components in the effective area; and defining the probability distribution associated with the layer as a probability distribution associated with the component, except that the standard deviation of the probability distribution associated with the layer is equal to the standard deviation of the probability distribution associated with the component divided by the square root of N.

22. The software program product of claim 12, wherein aggregating the results of the simulations comprises generating a probability distribution for the desired characteristic of the power distribution network based on the results of the simulations.
